(19) United States
(12) Patent Application Publication
(10) Pub. No.: US 2025/0274997 A1
(43) Pub. Date: Aug. 28, 2025

(54) METHOD FOR DEVICE-TO-DEVICE RELAY COMMUNICATION

(71) Applicant: ZTE Corporation, Shenzhen (CN)

(72) Inventors: Wanfu Xu, Shenzhen (CN); Mengzhen Wang, Shenzhen (CN); Lin Chen, Shenzhen (CN); Tao Qi, Shenzhen (CN)

(73) Assignee: ZTE Corporation, Shenzhen (CN)

(21) Appl. No.: 18/990,615

(22) Filed: Dec. 20, 2024

Related U.S. Application Data
(63) Continuation of application No. PCT/CN2023/076546, filed on Feb. 16, 2023.

(51) Int. Cl. H04W 76/14; H04W 88/04

(52) U.S. Cl. CPC H04W 76/14; H04W 88/04

(57) ABSTRACT

A wireless communication method for use in a third wireless terminal is disclosed. The method comprises: transmitting, to a fourth wireless terminal, a first PC5 link establishment request via a first relay terminal, wherein the first PC5 link establishment request comprises first relay selection information, receiving, from the fourth wireless terminal, a second PC5 link establishment request via a second relay terminal, wherein the second PC5 link establishment request comprises second relay selection information, selecting one of the first relay terminal or the second relay terminal based on the first relay selection information and the second relay selection information, and establishing a PC5 link with the fourth wireless terminal via the selected relay terminal.

### CROSS-REFERENCE TO RELATED APPLICATION

This application is a Continuation of PCT/CN2023/076546, filed on Feb. 16, 2023, titled “METHOD FOR DEVICE-TO-DEVICE RELAY COMMUNICATION”, and published as WO 2024/156121 A1 on Aug. 2, 2024, the entirety of which is incorporated herein by reference.

### TECHNICAL FIELD

This document is generally directed to wireless communications, and in particular to 5^{th} generation (5G) communications.

### BACKGROUND

With the development of wireless multimedia services, demands for high data rate and great user experience continuously increase, resulting in higher requirements of the system capacity and coverage of conventional cellular networks. On the other hand, demands for proximity services also increase because of application scenarios such as public security, social network, near-field data sharing and local advertisement. Traditionally, a cellular network using the base station as the center may have obvious limitations on supporting high data rates and proximity service. In order to satisfy such requirements, device-to-device (D2D) communication technology is proposed. By applying the D2D communication technology, burden of the cellular network can be relieved, power consumption of the user equipment (UE) can be reduced and the data rate can be increased and the robustness of the network infrastructure can be improved. Thus, the demands for high data rate and proximity services are greatly satisfied. In this context, D2D communication technology is also named proximity services (ProSe) or sidelink communications, wherein an interface between the UEs is called PC5 interface.

For supporting applications and services in a broader scope (e.g., indoor relay communication, smart agriculture, smart factory, public security, etc.), sidelink-based relay communications may be used to extend the coverage and improve the power consumption. For example, the sidelink-based communications may be applied in two application scenarios shown in FIG. 1:
1) UE-to-Network relay (Pattern 1): This type of relay is used for the UE in a weak/no coverage area. In FIG. 1, a UE1 in the weak/no coverage area is allowed to communicate with the network (e.g., base station) via a UE2 under a coverage of the network. The UE-to-Network relay may help the network operator to extend the coverage and increase the capacity of the network. Note that, in FIG. 1, the UE1 may be called remote UE and the UE2 may be called UE-to-Network relay.
2) UE-to-UE relay (Pattern 2): For an emergency scenario (e.g., earthquake) of the network working abnormally or for extending a sidelink communication range, the UEs may be allowed to communicate with each other via relay UE(s). For example, UE3 and UE4 in FIG. 1 communicate with each other via a UE5 or multiple relay UEs. The UE5 may be called UE-to-UE relay.

### SUMMARY

In long term evolution (LTE), two UE-to-Network replay technical solutions are provided, i.e., internet protocol (IP) based layer (Layer 3 (L3)) and access stratum layer (Layer 2 (L2)). Note that a Layer 3 relay forwards data based on the target IP address/port number and a Layer 2 relay performs route forwarding of the control plane and user plane data, so as to allow the network operator (i.e., core network (CN) network elements and base stations) to effectively manage remote devices (i.e., remote UEs). Because of significant differences between new radio (NR) sidelink communication and LTE sidelink communication (e.g., on frame structure, quality of service (QoS) processing, bearer configuration and establishment, etc.), LTE based sidelink relay technical solutions cannot be applied to the 5G/NR system. Thus, new technical solutions for the 5G/NR system are required.

This document relates to methods, systems, and devices for D2D communications, and in particular to discovery and selection/reselection of a relay for the D2D communications.

The present disclosure relates to a wireless communication method for use in a first wireless terminal. The method comprises:
determining a relay terminal for communications with a second wireless terminal, and
transmitting, to the second wireless terminal, relay information associated with the relay terminal.

Various embodiments may preferably implement the following features:

Preferably, the wireless communication method further comprises: determining at least one relay selection trigger condition is met.

Preferably, the relay information comprises a layer 2 identifier of the relay terminal.

The present disclosure relates to a wireless communication method for use in a second wireless terminal. The method comprises:
receiving, from a first wireless terminal, relay information associated with a relay terminal, and
establishing, based on the relay information, a PC5 link with the first wireless terminal via the relay terminal.

Various embodiments may preferably implement the following feature:

Preferably, the relay information comprises a layer 2 identifier of the relay terminal.

The present disclosure relates to a wireless communication method for use in a third wireless terminal. The method comprises:
transmitting, to a fourth wireless terminal, a first PC5 link establishment request via a first relay terminal, wherein the first PC5 link establishment request comprises first relay selection information,
receiving, from the fourth wireless terminal, a second PC5 link establishment request via a second relay terminal, wherein the second PC5 link establishment request comprises second relay selection information,
selecting one of the first relay terminal or the second relay terminal based on the first relay selection information and the second relay selection information, and
establishing a PC5 link with the fourth wireless terminal via the selected relay terminal.

Various embodiments may preferably implement the following features:

Preferably, the first relay selection information comprises a first round trip delay of the first PC5 link from the third wireless terminal to the fourth wireless terminal via the first relay terminal, and the second relay selection information comprises a second round trip delay of a second PC5 link from the fourth wireless terminal to the third wireless terminal via the first relay terminal.

Preferably, the first relay selection information comprises a first time stamp associated with the first PC5 link establishment request, and the second relay selection information comprises a second time stamp associated with the second PC5 link establishment request.

Preferably, the first relay selection information comprises a first random number associated with the first PC5 link establishment request, and the second relay selection information comprises a second random number associated with the second PC5 link establishment request.

Preferably, the first relay selection information comprises a first layer 2 identifier of the third wireless terminal, and the second relay selection information comprises a second layer 2 identifier of the fourth wireless terminal.

Preferably, the second relay terminal is selected based on the first relay selection information and the second relay selection information and establishing the PC5 link with the fourth wireless terminal via the selected relay terminal comprises:
transmitting, to the fourth wireless terminal via the second relay terminal, a PC5 link establishment accept message.

Preferably, the first relay terminal is selected based on the first relay selection information and the second relay selection information, and establishing the PC5 link with the fourth wireless terminal via the selected relay terminal comprises:
receiving, from the fourth wireless terminal via the first relay terminal, a PC5 link establishment accept message.

The present disclosure relates to a wireless communication method for use in a fifth wireless terminal. The method comprises:
transmitting, to a sixth wireless terminal, a first PC5 link establishment request via a first relay terminal,
receiving, from the sixth wireless terminal, a second PC5 link establishment request via a second relay terminal, wherein the first link establishment request collides with the second link establishment request, and
initiating a seventh link establishment request for the sixth wireless terminal after a predefined time.

The present disclosure relates to a first wireless terminal. The first wireless terminal comprises:
a processor, configured to determine a relay terminal for communications with a second wireless terminal, and
a communication unit, configured to transmit, to the second wireless terminal, relay information associated with the relay terminal.

Various embodiments may preferably implement the following feature:

Preferably, the processor is further configured to perform any of aforementioned wireless communication methods.

The present disclosure relates to a second wireless terminal. The second wireless terminal comprises:
a communication unit, configured to receive, from a first wireless terminal, relay information associated with a relay terminal, and
a processor, configured to establish, based on the relay information, a PC5 link with the first wireless terminal via the relay terminal.

Various embodiments may preferably implement the following feature:

Preferably, the processor is further configured to perform any of aforementioned wireless communication methods.

The present disclosure relates to a third wireless terminal. The third wireless terminal comprises:
a communication unit, configured to: transmit, to a fourth wireless terminal, a first PC5 link establishment request via a first relay terminal, wherein the first PC5 link establishment request comprises first relay selection information, and receive, from the fourth wireless terminal, a second PC5 link establishment request via a second relay terminal, wherein the second PC5 link establishment request comprises second relay selection information, and
a processor, configured to: select one of the first relay terminal or the second relay terminal based on the first relay selection information and the second relay selection information, and establish a PC5 link with the fourth wireless terminal via the selected relay terminal.

Various embodiments may preferably implement the following feature:

Preferably, the processor is further configured to perform any of aforementioned wireless communication methods.

The present disclosure relates to a fifth wireless terminal. The fifth terminal comprises:
a communication unit, configured to: transmit, to a sixth wireless terminal, a first PC5 link establishment request via a first relay terminal, receive, from the sixth wireless terminal, a second PC5 link establishment request via a second relay terminal, wherein the first link establishment request collides with the second link establishment request, and
a processor, configured to initiate a seventh link establishment request for the sixth wireless terminal after a predefined time.

Various embodiments may preferably implement the following feature:

Preferably, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a network.

FIG. 2 shows a schematic diagram of a process according to an embodiment of the present disclosure.

FIG. 3 shows a schematic diagram of a process according to an embodiment of the present disclosure.

FIG. 4 shows a schematic diagram of a process according to an embodiment of the present disclosure.

FIG. 5 shows a schematic diagram of a process according to an embodiment of the present disclosure.

FIG. 6 shows a schematic diagram of a process according to an embodiment of the present disclosure.

FIG. 7 shows a schematic diagram of a process according to an embodiment of the present disclosure.

FIG. 8 shows an example of a schematic diagram of a wireless terminal according to an embodiment of the present disclosure.

FIG. 9 shows an example of a schematic diagram of a wireless network node according to an embodiment of the present disclosure.

FIG. 10 shows a flowchart of a method according to an embodiment of the present disclosure.

FIG. 11 shows a flowchart of a method according to an embodiment of the present disclosure.

FIG. 12 shows a flowchart of a method according to an embodiment of the present disclosure.

FIG. 13 shows a flowchart of a method according to an embodiment of the present disclosure.

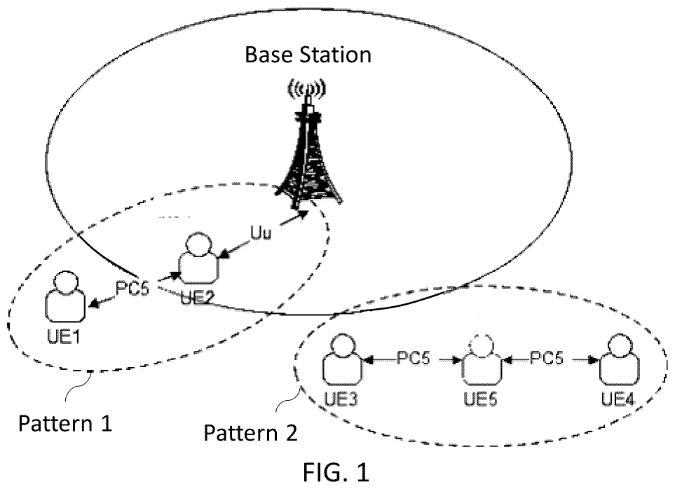

### DETAILED DESCRIPTION

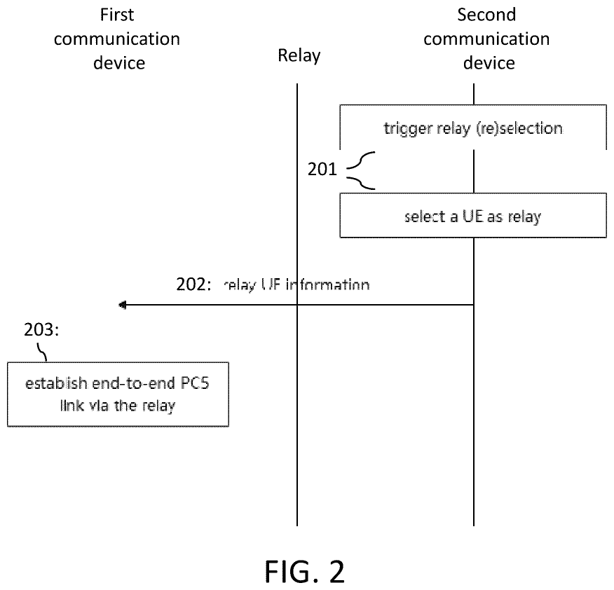

FIG. 2 shows a schematic diagram of a process according to an embodiment of the present disclosure. In FIG. 2, a second communication device may communicate with a first communication device, e.g., via a direct link or an indirect link. The process shown in FIG. 2 comprises the following steps:
Step 201: The second communication device detects relay selection/reselection trigger condition(s) is met.
Step 202: The second communication device selects a UE as relay.
Step 203: The second communication device notifies/transmits relay information to the first communication device. In an embodiment, the relay information comprises an L2 ID of the relay UE.
Step 204: Upon/After receiving the relay information, the first communication device establishes a new (end-to-end) PC5 link with the second communication device via the relay.

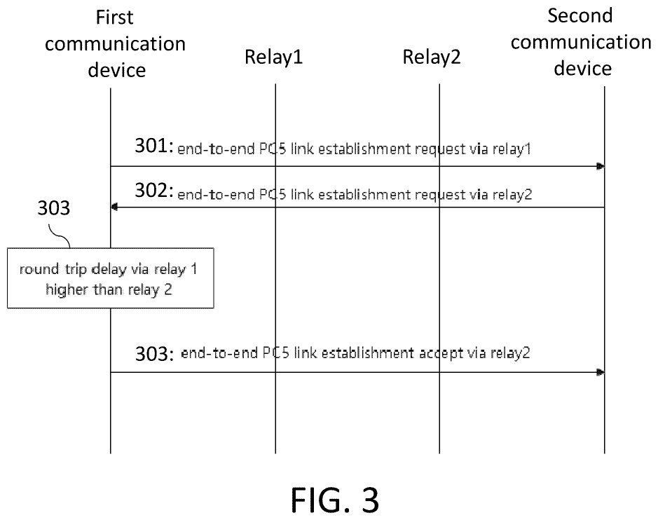

FIG. 3 shows a schematic diagram of a process according to an embodiment of the present disclosure. In FIG. 3, the first communication device and the second communication device may need to establish a direct link with each other. The process shown in FIG. 3 comprises the following steps:
Step 301: The first communication device sends an end-to-end DCR (direct communication request) message to the second communication device via a relay1, wherein a round trip delay RTD1 is included in the DCR message. For example, the round trip delay RTD1 may be associated with the relay link via the relay1.

In an embodiment, the end-to-end DCR message in step 301 may be replaced by a PC5-S message (e.g., PC5 link modification request).
Step 302: The second communication device also sends an end-to-end DCR message to the first communication device via a relay2, wherein a round trip delay RTD2 is included in the DCR message. The round trip delay RTD2 may be associated with the relay link via the relay2.

In an embodiment, the end-to-end DCR message in step 302 may be replaced by a PC5-S message (e.g., PC5 link modification request).
Step 303: The first communication device compares the RTD1 via the relay1 and the RTD2 via the relay2. In this embodiment, the RTD1 is higher than the RTD2 and the first communication device sends a DCA (direction communication accept) message to the second communication device via the relay2.

In an embodiment of the RTD1 higher than the RTD2, the second communication device sends the DCA (direction communication accept) message to the first communication device via the relay1.

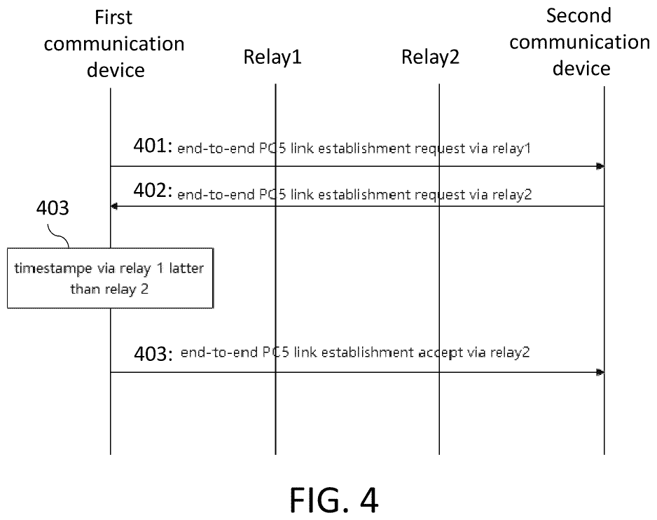

FIG. 4 shows a schematic diagram of a process according to an embodiment of the present disclosure. In FIG. 4, the first communication device and the second communication device may need to establish a direct link with each other. The process shown in FIG. 4 comprises the following steps:
Step 401: The first communication device sends an end-to-end DCR message to the second communication device via the relay1, wherein a time stamp TS1 is included in the DCR message. For example, the time stamp TS1 may be associated with the transmission of the DCR message.

In an embodiment, the end-to-end DCR message in step 401 may be replaced by a PC5-S message (e.g., PC5 link modification request).
Step 402: The second communication device also sends an end-to-end DCR message to the first communication device via the relay2, wherein a time stamp TS2 is included in the DCR message. The time stamp TS2 may be associated with the transmission of the DCR message.

In an embodiment, the end-to-end DCR message in step 402 may be replaced by a PC5-S message (e.g., PC5 link modification request).
Step 403: The first communication device compares the time stamp TS1 and the time stamp TS2. If the time stamp TS1 is later than the time stamp TS2, the first communication device send a DCA message to the second communication device via the relay2.

If the time stamp TS1 is before the time stamp TS2, the second communication device send a DCA message to the first communication device via the relay1.

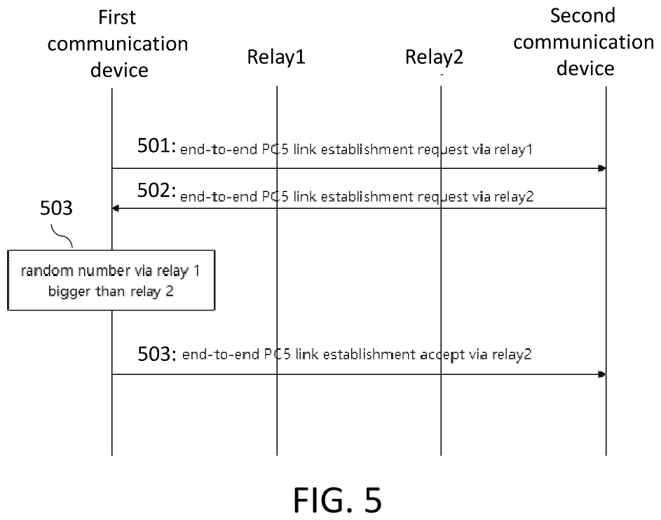

FIG. 5 shows a schematic diagram of a process according to an embodiment of the present disclosure. In FIG. 5, the first communication device and the second communication device may need to establish a PC5 link with each other. The process shown in FIG. 5 comprises the following steps:
Step 501: The first/second communication device adds a random number (e.g., 2 bits or 3 bits) in the Direct Link Request message (per hop or end-to-end).
Step 502: If the first/second communication device has sent the Direct Link Request message (per hop or end-to-end) to the second/first communication device before receiving a Direct Link Request message (per hop or end-to-end) from each other, the first/second communication device determines/knows that a collision occurs.
Step 503: If the collision occurs, the first/second communication device compares the random numbers in the transmitted Direct Link Request message and the received Direct Link Request message. The link has a smaller (or greater) random number is kept. In this embodiment, the Direct Link Request message transmitted from the second communication device to the first communication device has a smaller random number. Thus, the first communication device transmits a Direct Link Accept message to the second communication device via the relay2.

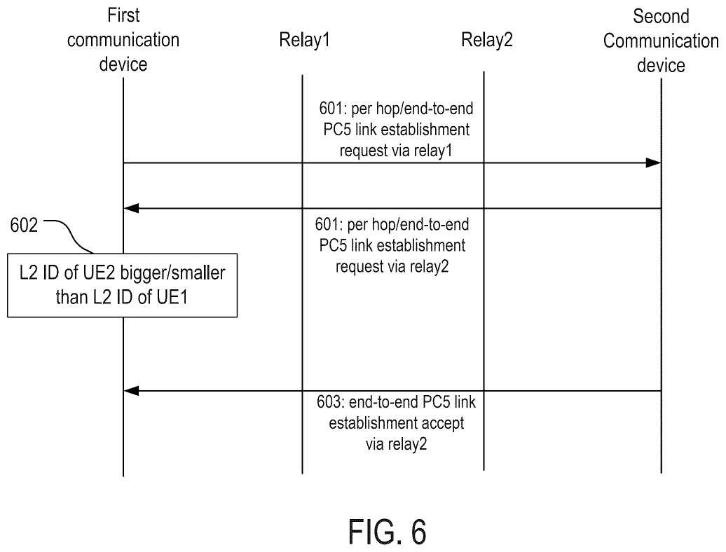

FIG. 6 shows a schematic diagram of a process according to an embodiment of the present disclosure. In FIG. 6, the first communication device and the second communication device may need to establish a PC5 link with each other. The process shown in FIG. 6 comprises the following steps:
Step 601: The first communication device and the second communication device transmit Direct Link Request messages (per hop or end-to-end) to each other, wherein the Direct Link Request messages comprises L2 ID of an initial communication device. For example, the Direct Link Request transmitted from the first communication device to the second communication device may comprise the L2 ID of the first communication device or another device initiating the Direct Link Request message.
Step 602: If the first/second communication device has sent the Direct Link Request message (per hop or end-to-end) to the second/first communication device before receiving a Direct Link Request message (per hop or end-to-end) from each other, the first/second communication device determines/knows that a collision occurs.
Step 603: If the collision occurs, the first/second communication device compares the L2 IDs in the transmitted Direct Link Request message and the received Direct Link Request message. The link has a greater (or smaller) L2 ID is kept. In this embodiment, the Direct Link Request message transmitted from the second communication device to the first communication device has a greater (or smaller) random number. Thus, the first communication device transmits a Direct Link Accept message to the second communication device via the relay2.

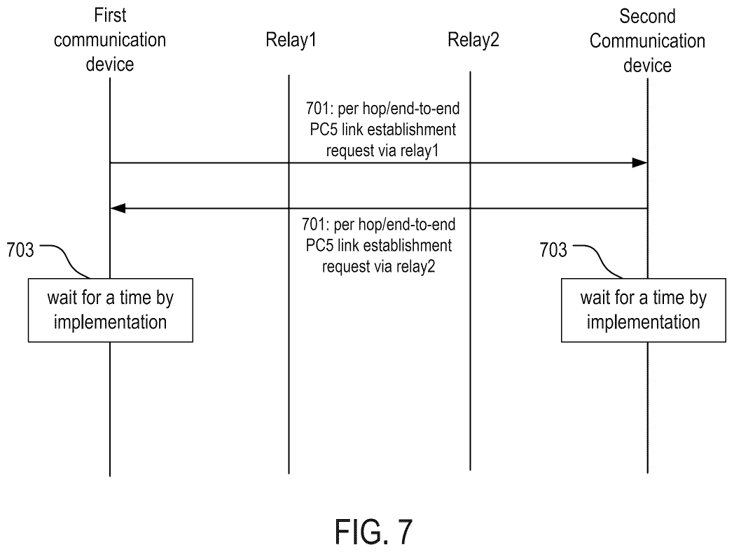

FIG. 7 shows a schematic diagram of a process according to an embodiment of the present disclosure. In FIG. 7, the first communication device and the second communication device may need to establish a PC5 link with each other. The process shown in FIG. 7 comprises the following steps:
Step 701: The first communication device and the second communication device transmit Direct Link Request messages (per hop or end-to-end) to each other.
Step 702: If the first/second communication device has sent the Direct Link Request message (per hop or end-to-end) to the second/first communication device before receiving a Direct Link Request message (per hop or end-to-end) from each other, the first/second communication device determines/knows that a collision occurs.
Step 703: The first communication device and the second communication device stop the corresponding Timer(s) and wait for a specific time for initiating a new Direct Link Request message (per hop or end-to-end). Note that the specific time may be determined based on implementation. For example, the specific time may be defined as Random (0˜timer), i.e., a random time from 0 to the value of timer. In an embodiment, the timer value can be (set to) a 5G ProSe direct link management timer or a PC5 unicast link management timer. That is, the first communication device and the second communication device may wait for different times.

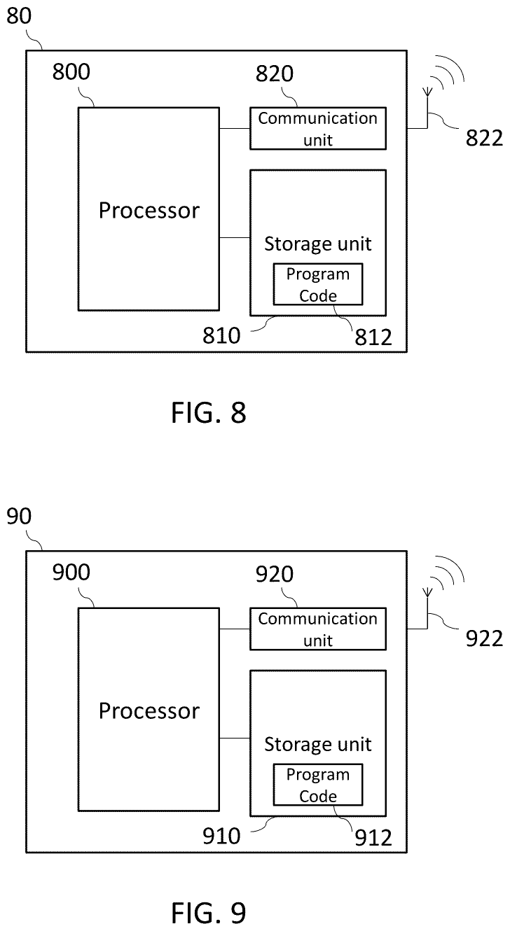

FIG. 8 relates to a schematic diagram of a wireless terminal 80 according to an embodiment of the present disclosure. The wireless terminal 80 may be a user equipment (UE), a mobile phone, a laptop, a tablet computer, an electronic book or a portable computer system and is not limited herein. The wireless terminal 80 may include a processor 800 such as a microprocessor or Application Specific Integrated Circuit (ASIC), a storage unit 810 and a communication unit 820. The storage unit 810 may be any data storage device that stores a program code 812, which is accessed and executed by the processor 800. Embodiments of the storage unit 810 include but are not limited to a subscriber identity module (SIM), read-only memory (ROM), flash memory, random-access memory (RAM), hard-disk, and optical data storage device. The communication unit 820 may a transceiver and is used to transmit and receive signals (e.g., messages or packets) according to processing results of the processor 800. In an embodiment, the communication unit 820 transmits and receives the signals via at least one antenna 822 shown in FIG. 8.

In an embodiment, the storage unit 810 and the program code 812 may be omitted and the processor 800 may include a storage unit with stored program code.

The processor 800 may implement any one of the steps in exemplified embodiments on the wireless terminal 80, e.g., by executing the program code 812.

The communication unit 820 may be a transceiver. The communication unit 820 may as an alternative or in addition be combining a transmitting unit and a receiving unit configured to transmit and to receive, respectively, signals to and from a wireless network node (e.g., a base station).

FIG. 9 relates to a schematic diagram of a wireless network node 90 according to an embodiment of the present disclosure. The wireless network node 90 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 90 may comprise (perform) at least one network function such as an access and mobility management function (AMF), a session management function (SMF), a user place function (UPF), a policy control function (PCF), an application function (AF), etc. The wireless network node 90 may include a processor 900 such as a microprocessor or ASIC, a storage unit 910 and a communication unit 920. The storage unit 910 may be any data storage device that stores a program code 912, which is accessed and executed by the processor 900. Examples of the storage unit 910 include but are not limited to a SIM, ROM, flash memory, RAM, hard-disk, and optical data storage device. The communication unit 920 may be a transceiver and is used to transmit and receive signals (e.g., messages or packets) according to processing results of the processor 900. In an example, the communication unit 920 transmits and receives the signals via at least one antenna 922 shown in FIG. 9.

In an embodiment, the storage unit 910 and the program code 912 may be omitted. The processor 900 may include a storage unit with stored program code.

The processor 900 may implement any steps described in exemplified embodiments on the wireless network node 90, e.g., via executing the program code 912.

The communication unit 920 may be a transceiver. The communication unit 920 may as an alternative or in addition be combining a transmitting unit and a receiving unit configured to transmit and to receive, respectively, signals to and from a wireless terminal (e.g., a user equipment or another wireless network node).

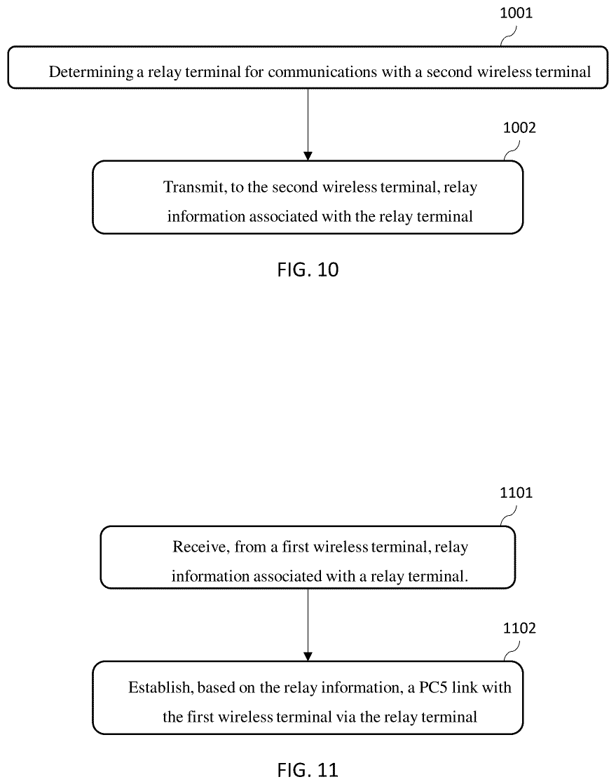

FIG. 10 shows a flowchart of a method according to an embodiment of the present disclosure. The method shown in FIG. 10 may be used in a first wireless terminal (e.g., UE or communication device) and comprises the following step:
Step 1001: Determining a relay terminal for communications with a second wireless terminal.
Step 1002: Transmit, to the second wireless terminal, relay information associated with the relay terminal.

In FIG. 10, the first wireless terminal determines/selects a relay terminal (e.g., UE) for communications with a second wireless terminal (e.g., UE) and transmits relay information associated with the relay terminal to the second wireless terminal, to establish a PC5 link with the second wireless terminal.

In an embodiment, the relay information may comprise an L2 ID of the relay terminal.

In an embodiment, the first wireless terminal determines/selects the relay terminal if determining at least one relay selection trigger condition or at least one relay reselection trigger condition is met/fulfilled.

FIG. 11 shows a flowchart of a method according to an embodiment of the present disclosure. The method shown in FIG. 11 may be used in a second wireless terminal (e.g., UE or communication device) and comprises the following step:
Step 1101: Receive, from a first wireless terminal, relay information associated with a relay terminal.
Step 1102: Establish, based on the relay information, PC5 link with the first wireless terminal via the relay terminal.

In FIG. 11, the second wireless terminal receives relay information associated with a relay terminal (e.g., UE) from a first wireless terminal (e.g., UE). Based on the relay information, the second wireless terminal establish an PC5 (e.g., end-to-end) link with the first wireless terminal.

In an embodiment, the relay information may comprise an L2 ID of the relay terminal.

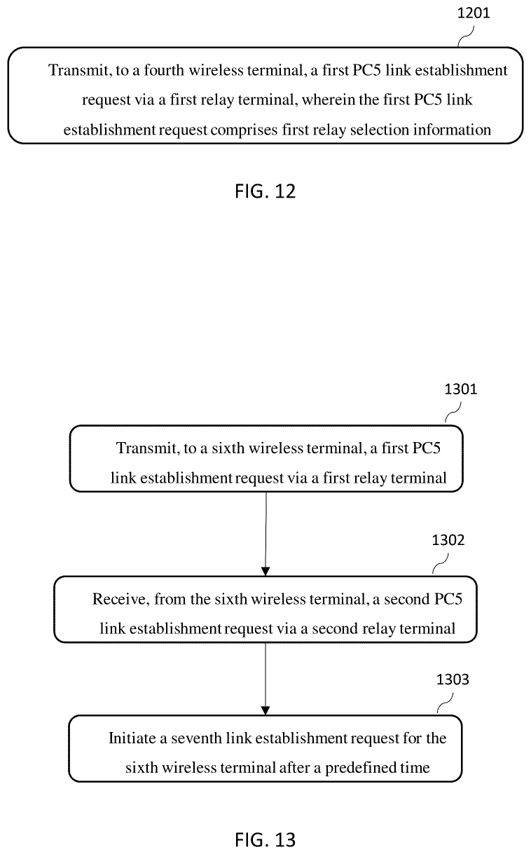

FIG. 12 shows a flowchart of a method according to an embodiment of the present disclosure. The method shown in FIG. 12 may be used in a third wireless terminal (e.g., UE or communication device) and comprises the following step:
Step 1201: Transmit, to a fourth wireless terminal, a first PC5 link establishment request via a first relay terminal, wherein the first PC5 link establishment request comprises first relay selection information.

In FIG. 12, the third wireless terminal transmits a first PC5 link establishment request via a first relay terminal (e.g., UE) to a fourth wireless terminal (e.g., UE). In this embodiment, the first PC5 link establishment request comprises first relay selection information which is used for a selection of the relay if a collision of PC5 link establishment request occurs/happens.

In an embodiment, the third wireless terminal may receive a second PC5 link establishment request via a second relay terminal, wherein the second PC5 link establishment request comprises second relay selection information. In this embodiment, the third wireless terminal may determine that the collision occurs. For example, the third wireless terminal determines that the collision occurs if:
the first PC5 link establishment request is transmitted before the reception of the second PC5 link establishment request, or
the second PC5 link establishment request is received within a period after the transmission of the first PC5 link establishment request, or
the second PC5 link establishment request is received before a reception of a response for the first PC5 link establishment request.

In an embodiment, the third wireless terminal selects one of the first relay terminal or the second relay terminal based on the first relay selection information and the second relay selection information and establishes a PC5 link with the fourth wireless terminal via the selected relay terminal.

In an embodiment, the relay selection information comprises a round trip delay. For example, the first relay selection information comprises a first round trip delay of the first PC5 link from the third wireless terminal to the fourth wireless terminal via the first relay terminal, and wherein the second relay selection information comprises a second round trip delay of a second PC5 link from the fourth wireless terminal to the third wireless terminal via the first relay terminal.

In an embodiment, the relay corresponding to the smaller round trip delay may be selected. As an alternative, the relay corresponding to the greater round trip delay may be selected.

In an embodiment, the relay selection information comprises a time stamp, e.g., associated with a transmission of the PC5 link establishment request. For example, the first relay selection information comprises a first time stamp associated with the first PC5 link establishment request, and the second relay selection information comprises a second time stamp associated with the second PC5 link establishment request.

In an embodiment, the relay terminal corresponding to (the PC5 link establishment request having) the earlier time stamp is selected. As an alternative, the relay terminal corresponding to (the PC5 link establishment request having) the later time stamp is selected.

In an embodiment, the relay selection information comprises a random number. For instance, the first relay selection information comprises a first random number associated with the first PC5 link establishment request, and the second relay selection information comprises a second random number associated with the second PC5 link establishment request

In an embodiment, the relay terminal corresponding to (the PC5 link establishment request having) the greater random number is selected. As an alternative, the relay terminal corresponding to (the PC5 link establishment request having) the smaller random number is selected.

In an embodiment, the relay selection information comprises the L2 ID of an initial terminal. For example, the first relay selection information comprises a first layer 2 identifier of the third wireless terminal, and the second relay selection information comprises a second layer 2 identifier of the fourth wireless terminal.

In an embodiment, the relay terminal corresponding to (the PC5 link establishment request having) the greater L2 ID is selected. As an alternative, the relay terminal corresponding to (the PC5 link establishment request having) the smaller L2 ID is selected.

In an embodiment, the first relay terminal is selected based on the first relay selection information and the second relay selection information. In this embodiment, the third wireless terminal receives a PC5 link establishment accept message from the fourth wireless terminal via the first relay terminal.

In an embodiment, the second relay terminal is selected based on the first relay selection information and the second relay selection information. In this embodiment, the third wireless terminal transmits a PC5 link establishment accept message to the fourth wireless terminal via the second relay terminal.

FIG. 13 shows a flowchart of a method according to an embodiment of the present disclosure. The method shown in FIG. 13 may be used in a fifth wireless terminal (e.g., UE or communication device) and comprises the following step:
Step 1301: Transmit, to a sixth wireless terminal, a first PC5 link establishment request via a first relay terminal.
Step 1302: Receive, from the sixth wireless terminal, a second PC5 link establishment request via a second relay terminal, wherein the first link establishment request collides with the second link establishment request.
Step 1303: Initiate a seventh link establishment request for the sixth wireless terminal after a predefined time.

In FIG. 13, the fifth wireless terminal transmits first PC5 link establishment request to a sixth wireless terminal via a first relay terminal (see, e.g., FIG. 10). In this embodiment, the fifth wireless terminal receives a second PC5 link establishment request from the sixth wireless terminal via a second relay terminal. In this embodiment, the first link establishment request collides with the second link establishment request. For example, the first link establishment request collides with the second link establishment request because:
the first PC5 link establishment request is transmitted before the reception of the second PC5 link establishment request, or
the second PC5 link establishment request is received within a period after the transmission of the first PC5 link establishment request, or
the second PC5 link establishment request is received before a reception of a response for the first PC5 link establishment request.

In the present disclosure, the PC5 link establishment request may be replaced by a PC5-S message (e.g., PC5 link modification request). That is the above first/second PC5 link establishment request may be a PC5-S message (e.g., PC5 link modification request).

Under such conditions, the fifth wireless terminal may wait a predefined time before initiating another link establishment request to the sixth wireless terminal. The predefined time may be based on implementation. For example, the specific time may be defined as Random (0˜timer), i.e., a random time from 0 to the value of timer. In an embodiment, the timer value can be (set to) a 5G ProSe direct link management timer or a PC5 unicast link management timer. That is, the first communication device and the second communication device may wait for different times.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a third wireless terminal, the method comprising:
transmitting, to a fourth wireless terminal, a first PC5 link establishment request via a first relay terminal, wherein the first PC5 link establishment request comprises first relay selection information,
receiving, from the fourth wireless terminal, a second PC5 link establishment request via a second relay terminal, wherein the second PC5 link establishment request comprises second relay selection information,
selecting one of the first relay terminal or the second relay terminal based on the first relay selection information and the second relay selection information, and
establishing a PC5 link with the fourth wireless terminal via the selected relay terminal.

2. The wireless communication method of claim 1, wherein the first relay selection information comprises a first round trip delay of the first PC5 link from the third wireless terminal to the fourth wireless terminal via the first relay terminal, and
wherein the second relay selection information comprises a second round trip delay of a second PC5 link from the fourth wireless terminal to the third wireless terminal via the first relay terminal.

3. The wireless communication method of claim 1, wherein the first relay selection information comprises a first time stamp associated with the first PC5 link establishment request, and
wherein the second relay selection information comprises a second time stamp associated with the second PC5 link establishment request.

4. The wireless communication method of claim 1, wherein the first relay selection information comprises a first random number associated with the first PC5 link establishment request, and
wherein the second relay selection information comprises a second random number associated with the second PC5 link establishment request.

5. The wireless communication method of claim 1, wherein the first relay selection information comprises a first layer 2 identifier of the third wireless terminal, and
wherein the second relay selection information comprises a second layer 2 identifier of the fourth wireless terminal.

6. The wireless communication method of claim 1, wherein the second relay terminal is selected based on the first relay selection information and the second relay selection information, and
wherein establishing the PC5 link with the fourth wireless terminal via the selected relay terminal comprises:
transmitting, to the fourth wireless terminal via the second relay terminal, a PC5 link establishment accept message.

7. The wireless communication method of claim 1, wherein the first relay terminal is selected based on the first relay selection information and the second relay selection information, and
wherein establishing the PC5 link with the fourth wireless terminal via the selected relay terminal comprises:
receiving, from the fourth wireless terminal via the first relay terminal, a PC5 link establishment accept message.

8. A wireless communication method for use in a fifth wireless terminal, the method comprising:
transmitting, to a sixth wireless terminal, a first PC5 link establishment request via a first relay terminal,
receiving, from the sixth wireless terminal, a second PC5 link establishment request via a second relay terminal, wherein the first link establishment request collides with the second link establishment request, and
initiating a seventh link establishment request for the sixth wireless terminal after a predefined time.

9. A third wireless terminal, comprising:
a communication unit, configured to:
transmit, to a fourth wireless terminal, a first PC5 link establishment request via a first relay terminal, wherein the first PC5 link establishment request comprises first relay selection information, and
receive, from the fourth wireless terminal, a second PC5 link establishment request via a second relay terminal, wherein the second PC5 link establishment request comprises second relay selection information, and
a processor, configured to:
select one of the first relay terminal or the second relay terminal based on the first relay selection information and the second relay selection information, and
establish a PC5 link with the fourth wireless terminal via the selected relay terminal.

10. The third wireless terminal of claim 9,
wherein the first relay selection information comprises a first round trip delay of the first PC5 link from the third wireless terminal to the fourth wireless terminal via the first relay terminal, and
wherein the second relay selection information comprises a second round trip delay of a second PC5 link from the fourth wireless terminal to the third wireless terminal via the first relay terminal.

11. A fifth wireless terminal, comprising:
a communication unit, configured to:
transmit, to a sixth wireless terminal, a first PC5 link establishment request via a first relay terminal,
receive, from the sixth wireless terminal, a second PC5 link establishment request via a second relay terminal, wherein the first link establishment request collides with the second link establishment request, and
a processor, configured to initiate a seventh link establishment request for the sixth wireless terminal after a predefined time.

12. A non-transitory computer-readable medium having code stored thereupon, wherein the code, when executed by a processor, causes the processor to implement the wireless communication method according to claim 1.
